(19) United States
(12) Patent Application Publication
(10) Pub. No.: US 2026/0121206 A1
(43) Pub. Date: Apr. 30, 2026

(54) BATTERY PACK FOR A POWER TOOL AND BATTERY SYSTEM

(71) Applicant: Nanjing Chervon Industry Co., Ltd., Nanjing (CN)

(72) Inventors: Lisong Zhang, Nanjing (CN); Youchen Liu, Nanjing (CN); Jing Li, Nanjing (CN); Dacheng Ye, Nanjing (CN)

(21) Appl. No.: 19/346,010

(22) Filed: Sep. 30, 2025

(30) Foreign Application Priority Data
Oct. 25, 2024 (CN) 202411507407.3

(51) Int. Cl. H01M 50/296; H01M 50/213; H01M 50/247; H01M 50/271

(52) U.S. Cl. CPC H01M 50/296; H01M 50/213; H01M 50/247; H01M 50/271; H01M 2220/30

(57) ABSTRACT

A battery pack includes: a housing assembly; a battery module disposed within the housing assembly; a first battery interface, where the first battery interface is configured to be detachably and electrically connectable to at least a first power tool to supply power to the first power tool; a second battery interface, where the second battery interface is configured to be detachably and electrically connectable to at least a second power tool to supply power to the second power tool, where a discharge current of the first battery interface and a discharge current of the second battery interface are each greater than 20 A; and at least one guide rail, where the at least one guide rail is formed on the housing assembly and is configured to guide electrical connection of at least one of the first battery interface and the second battery interface.

### RELATED APPLICATION INFORMATION

This application claims the benefit under 35 U.S.C. § 119 (a) of Chinese Patent Application No. 202411507407.3, filed on Oct. 25, 2024, which application is incorporated herein by reference in its entirety.

### TECHNICAL FIELD

The present application relates to the technical field of power tools, for example, a battery pack for a power tool and a battery system.

### BACKGROUND

Benefiting from technological developments, the entire power tool industry shows a trend toward lithium electrification and intelligentization. At present, most products are powered by battery packs. However, there are relatively large differences among different categories and different generations of products, which bring many difficulties to the design and use of battery packs.

This part provides background information related to the present application, and the background information is not necessarily the existing art.

### SUMMARY

A battery pack for a power tool includes: a housing assembly; a battery module disposed within the housing assembly; a first battery interface, where the first battery interface is configured to be detachably and electrically connectable to at least a first power tool to supply power to the first power tool; a second battery interface, where the second battery interface is configured to be detachably and electrically connectable to at least a second power tool to supply power to the second power tool, where a discharge current of the first battery interface and a discharge current of the second battery interface are each greater than 20 A; and at least one guide rail, where the at least one guide rail is formed on the housing assembly and is configured to guide electrical connection of at least one of the first battery interface and the second battery interface.

In some examples, a first guide rail is configured to guide electrical connection between the first battery interface and the first power tool, and a second guide rail is configured to guide electrical connection between the second battery interface and the second power tool.

In some examples, the first guide rail and the second guide rail are provided on different planes.

In some examples, the first battery interface is disposed on the rear end surface of the battery pack for a power tool, and the second battery interface is disposed on the upper end surface of the battery pack for a power tool.

In some examples, the rated voltage of the first battery interface and the rated voltage of the second battery interface are substantially the same.

In some examples, the rated voltage of the first battery interface and the rated voltage of the second battery interface are different from each other.

In some examples, the first battery interface includes a positive terminal, a negative terminal, and a communication terminal, where the positive terminal and the negative terminal are discrete terminals.

In some examples, the first battery interface is configured to be detachably and electrically connected to a first electric device, and the second battery interface is configured to be detachably and electrically connected to a second electric device.

In some examples, the second battery interface is an electrode tab interface, the second battery interface includes electrode tabs, and the second electric device is mounted to or detached from the second battery interface through a clip-type plug-in method along the extension direction of each of the electrode tabs.

In some examples, a Universal Serial Bus (USB) interface is further included, where the USB interface is disposed on the rear end surface of the battery pack for a power tool.

In some examples, a device for displaying an electric quantity is further included, where the device for displaying an electric quantity is disposed at the front end of the battery pack for a power tool and is configured to display at least information about an electric quantity of the battery pack for a power tool.

A battery pack includes: a housing assembly; a battery module disposed within the housing assembly; at least one battery interface configured to be detachably and electrically connectable to at least a power tool to supply power to the power tool; and a cover, where the cover is mounted on the housing assembly, is configured to cover at least one battery interface, and has two different mounting positions on the housing assembly.

In some examples, the battery pack includes: a first battery interface, where the first battery interface is configured to be detachably and electrically connectable to at least a first power tool to supply power to the first power tool; and a second battery interface, where the second battery interface is configured to be detachably and electrically connectable to at least a second power tool to supply power to the second power tool.

In some examples, the cover is at a first mounting position on the housing assembly to cover the second battery interface, and the cover is at a second mounting position on the housing assembly to expose the second battery interface.

In some examples, the cover is detachably mounted at the first mounting position or the second mounting position on the housing assembly.

In some examples, a rotary shaft is further included, where the cover is configured to be switched between the first mounting position and the second mounting position about a rotary shaft.

In some examples, a locking assembly is further included, where the locking assembly is configured to be capable of at least locking the cover to or releasing the cover from the first mounting position.

In some examples, the locking assembly is further configured to lock the battery pack to an electric device in the case where the battery pack is electrically connected to the electric device through the first battery interface.

In some examples, the locking assembly is further configured to lock the battery pack to the electric device in the case where the battery pack is electrically connected to the electric device through the second battery interface.

In some examples, the locking assembly includes an unlocking button, where the unlocking button is disposed on a side surface of the battery pack.

In some examples, a USB interface is further included, where the USB interface is disposed on the rear end surface of the battery pack for a power tool.

A battery system includes: a battery pack, a first electric device, and a second electric device. The battery pack includes: a housing assembly; a battery module disposed within the housing assembly; a first battery interface, where the first battery interface is configured to be detachably and electrically connectable to the first electric device to charge and discharge the first electric device; a second battery interface, where the second battery interface is configured to be detachably and electrically connectable to the second electric device to charge and discharge the second electric device, where a discharge current of the first battery interface and a discharge current of the second battery interface are each greater than 20 A; and at least one guide rail, where the at least one guide rail is formed on the housing assembly and is configured to guide electrical connection of at least one of the first battery interface and the second battery interface. The first electric device includes a first device interface configured to be electrically coupled to the first battery interface. The second electric device includes a second device interface configured to be electrically coupled to the second battery interface.

In some examples, the second battery interface is an electrode tab interface, the second battery interface includes electrode tabs, and the second electric device is directly inserted into the second battery interface along the extension direction of each of the electrode tabs.

In some examples, the first battery interface includes a positive terminal, a negative terminal, and a communication terminal, where the positive terminal and the negative terminal are discrete terminals.

In some examples, the at least one guide rail includes a first guide rail configured to guide electrical connection between the first battery interface and the first power tool; and a second guide rail configured to guide electrical connection between the second battery interface and the second power tool.

In some examples, the rated voltage of the first battery interface and the rated voltage of the second battery interface are substantially the same.

In some examples, the first battery interface is disposed on the rear end surface of the battery pack, and the second battery interface is disposed on the upper end surface of the battery pack.

In some examples, a cover is further included, where the cover is mounted on the housing assembly and configured to cover at least the second battery interface, and the cover is at a first mounting position on the housing assembly to cover the second battery interface and is at a second mounting position on the housing assembly to expose the second battery interface.

In some examples, a locking assembly is further included, where the locking assembly is configured to be capable of at least locking the cover to or releasing the cover from the first mounting position and includes an unlocking button disposed on a side surface of the battery pack.

In some examples, the locking assembly is further configured to lock the battery pack to the first electric device in the case where the battery pack is electrically connected to the first electric device through the first battery interface, and/or the locking assembly is further configured to lock the battery pack to the second electric device in the case where the battery pack is electrically connected to the second electric device through the second battery interface.

In some examples, a USB interface is further included, where the USB interface is disposed on the rear end surface of the battery pack for a power tool.

A battery pack includes: a housing assembly; a battery module disposed within the housing assembly; a first battery interface, where the first battery interface is disposed on the rear end surface of the battery pack or the front end surface of the battery pack and configured to be detachably and electrically connectable to a first electric device to charge and discharge the first electric device; a first guide rail formed on a side surface of the housing assembly and configured to guide electrical connection of the first battery interface; a locking assembly configured to operably lock the battery pack on the first electric device electrically connected to the first battery interface.

In some examples, the first battery interface includes a positive terminal, a negative terminal, and a communication terminal, where the positive terminal and the negative terminal are discrete terminals.

In some examples, the locking assembly includes a locking portion, where the locking portion is disposed in the first guide rail and configured to lock the battery pack to the first electric device in the case where the battery pack is electrically connected to the first electric device through the first battery interface.

In some examples, the locking assembly further includes an unlocking button, where the unlocking button is disposed on a side surface of the battery pack and is configured to operably unlock the battery pack and the first electric device from the locking portion.

In some examples, a USB interface is further included and is disposed on the front end surface of the battery pack or the rear end surface of the battery pack.

In some examples, a device for displaying an electric quantity is further included, where the device for displaying an electric quantity is disposed at the front end of the battery pack and is configured to display at least information about an electric quantity of the battery pack.

In some examples, the first electric device includes a first power tool and a first charging device.

A battery system includes the battery pack described above, a handheld second power tool, and a first conversion apparatus. The handheld second power tool includes a second device interface. The first conversion apparatus includes: a first adapter interface configured to be electrically coupled to a first battery interface; and a second adapter interface configured to be electrically coupled to the second device interface.

In some examples, the second adapter interface is an electrode tab interface, the second adapter interface includes electrode tabs, and the handheld second power tool is mounted to or detached from the second adapter interface through a clip-type plug-in method along the extension direction of each of the electrode tabs.

In some examples, the first adapter interface is disposed at the front end of the first conversion apparatus or the rear end of the first conversion apparatus, and the second adapter interface is disposed on the upper end surface of the first conversion apparatus.

A battery system includes a battery pack, a handheld first power tool, and a second conversion apparatus. The battery pack includes: a housing assembly; a battery module disposed within the housing assembly; a second battery interface which is an electrode tab interface and includes electrode tabs; and a second guide rail, where the second guide rail is formed on the housing assembly and configured to guide electrical connection of the second battery interface. The handheld first power tool includes a first device interface. The second conversion apparatus includes: a third adapter interface, where the third adapter interface is configured to be mounted to or detached from the second battery interface through direct insertion or direct removal along the extension direction of each of the electrode tabs; and a fourth adapter interface, where the fourth adapter interface is disposed at the rear end of the second conversion apparatus or the front end of the second conversion apparatus and is configured to be electrically coupled to the first device interface.

In some examples, the fourth adapter interface includes a positive terminal, a negative terminal, and a communication terminal, where the positive terminal and the negative terminal are discrete terminals.

In some examples, the third adapter interface is disposed on the upper end surface of the second conversion apparatus or the lower end surface of the second conversion apparatus.

### BRIEF DESCRIPTION OF THE DRAWINGS

FIG. 1 is a schematic view showing a scenario in which a battery pack supplies power to power tools in the present application.

FIG. 2 is a perspective view of a battery pack (a battery pack for a power tool/a transition battery pack) as an example of the present application.

FIG. 3 is a perspective view of some internal structures of the battery pack shown in FIG. 2 with part of a housing removed.

FIG. 4A is a perspective view of the battery pack shown in FIG. 2 with a cover mounted at a first mounting position.

FIG. 4B is a schematic view of the battery pack shown in FIG. 4A with a cover detached from a first mounting position.

FIG. 4C is a schematic view of the battery pack shown in FIG. 4B with a cover to be mounted at a second mounting position.

FIG. 4D is a perspective view of the battery pack shown in FIG. 2 with a cover mounted at a second mounting position.

FIG. 5A is a plan view of a battery pack shown in another example with a cover mounted at a first mounting position.

FIG. 5B is a schematic view of the battery pack shown in FIG. 5A with a cover rotated away from a first mounting position.

FIG. 5C is a schematic view of the battery pack shown in FIG. 5B with a cover to be rotated to a second mounting position.

FIG. 5D is a plan view of a battery pack shown in another example with a cover mounted at a second mounting position.

FIG. 6 is a schematic view of a battery system formed by the battery pack shown in FIG. 2, a first power tool, and a second power tool, as one example of the present application.

FIG. 7 is a schematic view showing that the battery pack and the second power tool in the battery system shown in FIG. 6 are used in conjunction.

FIG. 8 is a schematic view showing that the battery pack and the first power tool in the battery system shown in FIG. 6 are used in conjunction.

FIG. 9 is a perspective view of a battery pack (a first battery pack) as another example of the present application.

FIG. 10 is a perspective view of some internal structures of the battery pack shown in FIG. 9 with part of a housing removed.

FIG. 11 is a schematic view of a battery system formed by the battery pack shown in FIG. 9 and a first power tool, as another example of the present application.

FIG. 12 is a schematic view of a battery system formed by the battery pack shown in FIG. 9 and a second power tool, as another example of the present application.

FIG. 13 is a schematic view of a battery system formed by a second battery pack and a first power tool, as another example of the present application.

FIG. 14 is a perspective view of a charging device as an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

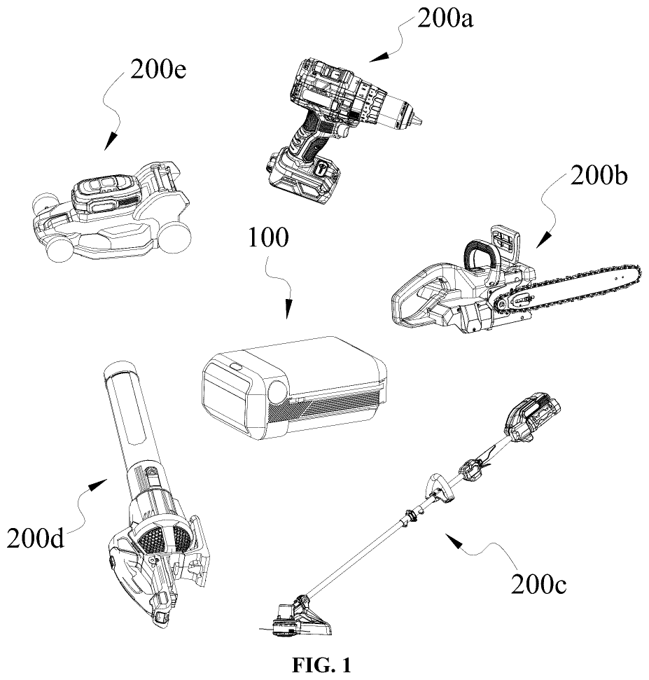

The present application mainly provides technical solutions related to a battery pack and a battery system, so as to solve a problem about system compatibility between the battery pack and a power tool or a charging device. FIG. 1 is a schematic view showing scenarios in which the battery pack supplies power to different power tools in the present application. Referring to FIG. 1, power tools 200 mounted with and powered by the battery pack 100 include not only various different types of power tools but also the same type of power tools of different models or different generations. The power tools 200 powered by the battery include, but are not limited to, an electric drill 200a, a chainsaw 200b, a string trimmer 200c, a blower 200d, and a robotic mower 200e shown in FIG. 1. In the present application, the power tools 200 fed by the battery pack 100 are mainly handheld power tools, such as a pruner, a nail gun, and a reciprocating saw. Of course, the battery pack 100 may also be configured to supply power to other power tools. In some examples, the power tools 200 fed by the battery pack 100 of the present application may include table tools, for example, a table saw, a miter saw, and a metal cutter. In some examples, the power tools 200 fed by the battery pack 100 of the present application may include push tools or riding tools, for example, a push mower, a push snow thrower, a riding mower, and a stand-on mower. In some examples, the power tools 200 fed by the battery pack 100 of the present application may include outdoor wheeled tools, including outdoor electric vehicles such as a farmer's vehicle and a golf cart. In some examples, the power tools 200 fed by the battery pack 100 of the present application may include robotic tools, including a robotic mower and a robotic snow thrower. Alternatively, in some examples, the power tools 200 may be garden tools, including a pruner, a blower, a mower, and a string trimmer. In some examples, the power tools 200 may be decorating tools, including a screwdriver, a nail gun, a glue gun, a sander, and an electric circular saw. In some examples, the power tools 200 may be cutting tools, including a reciprocating saw, a jigsaw, an electric circular saw, and a chainsaw. In some examples, the power tools 200 may be fastening tools, including an electric drill, a screwdriver, and an electric hammer. In some examples, the power tools 200 may be sanding tools, including an angle grinder and a sander. In some examples, the power tools 200 may be other tools, such as an electric lamp, a fan, a vacuum cleaner, and a compact household hair dryer. It is to be understood that on the premise that the characteristics are not contradictory, more types of power tools 200 that are fed by the battery pack 100 of the present application and have not been shown above may exist.

The preceding power tool 200 generally has a battery mounting portion to which the battery pack 100 is detachably and electrically connected. The specific positions of the battery mounting portions of different power tools 200 on the power tools and the specific structures of the battery mounting portions may be the same, different, partially the same, or partially different. The structural differences of the battery mounting portions may be reflected in the interface forms or the mounting manners. For example, assuming that some categories of power tools have similar power supply requirements, the same battery pack may be inserted into these various power tools to supply power thereto. Regardless of the specific positions on the tools, these various power tools may have battery mounting portions with the same structure. Thus, the preceding battery pack can be used as a universal battery pack of a certain generation to serve various power tools launched in the same period or recently. In this manner, a user can use various power tools by purchasing a limited number of battery packs. However, in many scenarios, even if different types of power tools have similar power supply requirements, these power tools still use different battery packs separately. Handheld power tools are used as an example. At present, household handheld power tools such as a vacuum cleaner, a fan, and an electric lamp generally use battery packs that are not compatible with the battery packs used by mainstream industrial handheld power tools for cutting, fastening, and sanding. The household handheld power tools and the mainstream industrial handheld power tools each have different battery mounting portions. In addition, to adapt to the rapid advancement of technologies and changes in relevant standards, a battery pack used after product iteration may differ from that used in an original product. Although, ideally, unified batteries across multiple devices are desired by users, the preceding situation remains unavoidable. Based on this, the present application proposes some technical solutions for a battery pack and a battery system.

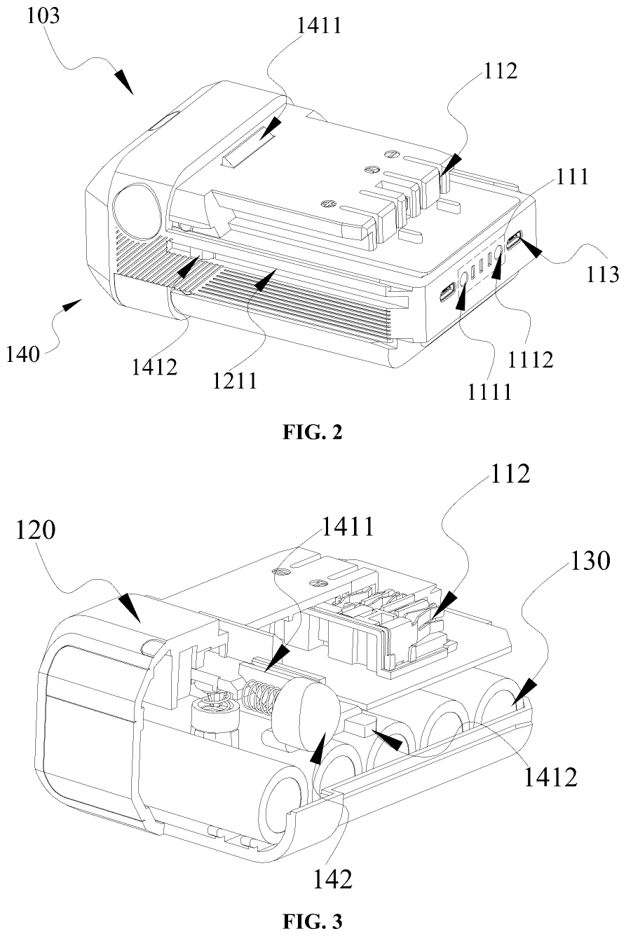

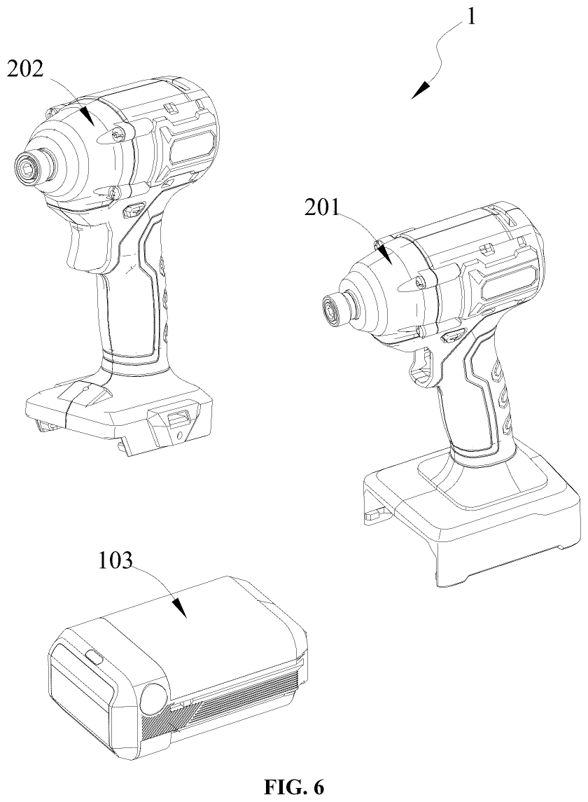

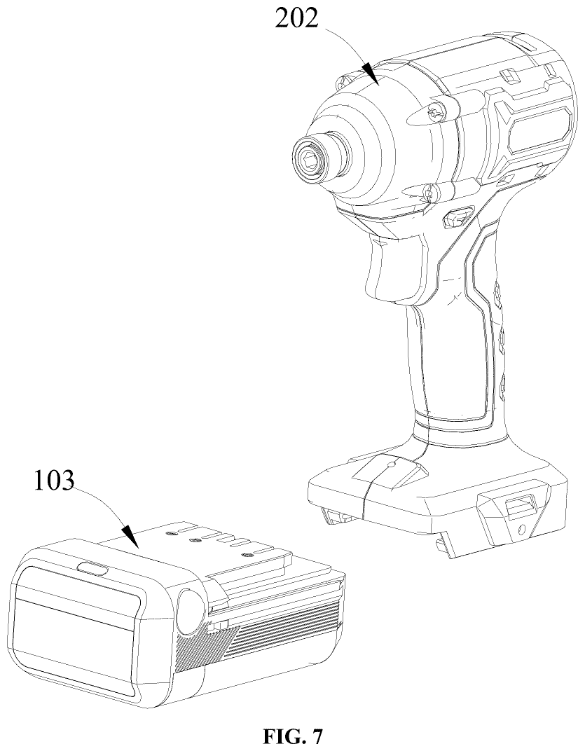

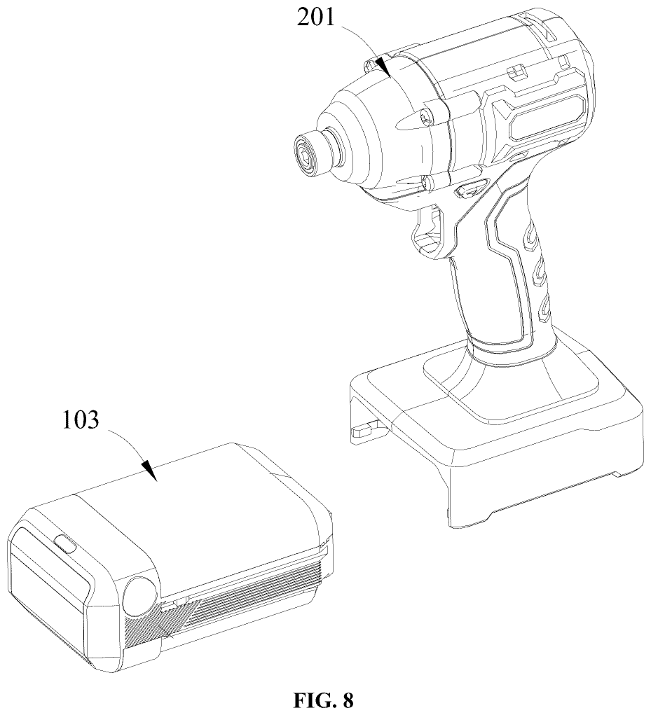

Firstly, in an optional example of the present application, referring to FIGS. 2 to 8, a battery pack 103 for a power tool is proposed. The battery pack 103 for a power tool has at least two battery interfaces, intended to be compatible with two types of power tools or two generations of power tools. In some examples, the battery pack 103 for a power tool is a transitional product between a new-generation battery pack 101 and an old-generation battery pack 102, that is, the battery pack 103 is a transitional battery pack, so as to enable smooth iteration from a previous-generation product to a next-generation product. The battery pack 103 for a power tool has two battery interfaces which can be electrically coupled to an interface of a new-generation power tool 201 and an interface of an old-generation power tool 202, respectively. That is, the two battery interfaces can be the same as or similar to an interface of the new-generation battery pack 101 and an interface of the old-generation battery pack 102, respectively. As shown in FIGS. 6 to 8, the present application further proposes a battery system 1 including the preceding battery pack 103. The battery system 1 includes a first electric device and a second electric device in addition to the battery pack 103. When the system is in use, the system may appear in the form of the battery pack 103 and the first electric device as shown in FIG. 8 or the form of the battery pack 103 and the second electric device as shown in FIG. 7. The preceding electric device may include at least a power tool that requires power supplied by the battery pack 103. The first electric device and the second electric device may be two types of power tools or two generations of power tools, respectively. The first electric device includes a first power tool 201, and the second electric device includes a second power tool 202. It is apparent that the first power tool 201 and the second power tool 202 differ at least in interfaces thereof. In other words, the first power tool 201 has a battery mounting portion different from that of the second power tool 202. In addition, the electric device may further include a charging device 203 for charging the battery pack. The first electric device may further include a first charging device matched with the interface of the first power tool 201, and the second electric device may further include a second charging device matched with the interface of the second power tool 202. In some examples, the battery pack 103 may be charged by either the first charging device or the second charging device. In other examples, it is not excluded that some charging devices can charge battery packs having different battery interfaces.

As shown in FIGS. 2 and 3, the preceding battery pack 103 may include a housing assembly 120 and a battery module 130. The housing assembly 120 forms the appearance of the preceding battery pack 103, and an accommodation space is formed inside the housing assembly 120. The battery module 130 is disposed in the accommodation space and may include multiple cells used as energy storage elements in the battery pack 103. The material and dimension of the housing assembly 120 and the type and number of the cells are not specifically limited. As described above, the preceding battery pack 103 further includes the two battery interfaces: a first battery interface 111 and a second battery interface 112. The first battery interface 111 of the battery pack 103 is detachably and electrically connectable to the first power tool 201 to supply power to the first power tool 201. The second battery interface 112 is detachably and electrically connectable to the second power tool 202 to supply power to the second power tool 202. For example, the first power tool 201 has a first device interface, and the second power tool 202 has a second device interface. The first battery interface 111 of the battery pack 103 is electrically coupled to the first device interface of the first power tool 201 directly. The second battery interface 112 is electrically coupled to the second device interface of the second power tool 202 directly. The interfaces are electrically coupled to each other directly, which includes both the adaptation of electrical characteristics and the adaptation of mechanical characteristics. In other words, when the battery interface is interconnected to the device interface, no intermediate connecting wire is required, and both electrical connection and mechanical connection are simultaneously implemented based on mutually compatible structures. In addition, unlike some low-power interfaces used for transmitting data or assisting in charging smart devices, such as a USB interface, the first battery interface 111 and the second battery interface 112 are both interfaces that can transmit charging electric energy and discharging electric energy with the cells. To meet the performance requirements of power tools, a discharge current of the first battery interface 111 and a discharge current of the second battery interface 112 are each greater than 20 A. It is to be noted that the discharge current of the interface described herein refers to a discharge current in the case where the battery module 130 transmits electric energy through the battery interface and does not refer to a discharge current in the case of power outage or power shortage. The discharge current of the interface described herein may be explained as follows: the maximum discharge current or the average discharge current of the first battery interface 111 and the maximum discharge current or the average discharge current of the second battery interface 112 are greater than 20 A. In addition, the battery pack 103 for a power tool is mounted to or detached from the first power tool 201 or the second power tool 202 through a guide rail. At least one guide rail is formed on the housing assembly 120 of the battery pack 103 to guide electrical connection of at least one of the preceding battery interfaces. The guide rail is generally a linear guide rail, which may include a single linear rail or two parallel linear rails. It is to be understood that even if the guide rail for electrical connection of the same battery interface includes multiple parallel linear rails, it is regarded as one guide rail.

The first battery interface 111 and the second battery interface 112 on the battery pack 103 are further described below. The first battery interface 111 and the second battery interface 112 are provided so that the battery pack 103 is adapted to both the first electric device and the second electric device. As described above, to achieve system compatibility, although both the first battery interface 111 and the second battery interface 112 serve as interfaces that can transmit electric energy with the power tool and have the discharge currents of greater than 20 A, the first battery interface 111 and the second battery interface 112 should have different mechanical structures. The differences herein include, but are not limited to, different interface forms, and different shapes, dimensions, and positions of the corresponding battery mounting portions.

In some examples, as shown in FIG. 3, the preceding second battery interface 112 is an electrode tab interface. The interface includes multiple electrode tabs. The electrode tabs may form a positive terminal, a negative terminal, a communication terminal, a temperature terminal, and the like and may be presented in the form of clips or contacts. Specifically, the electrode tabs may be designed to mate with the second device interface on the second electric device such as the second power tool 202. For example, the electrode tabs may be configured as elastic clips having openings in the extension direction of the clips to form the preceding terminals of the second battery interface 112. The second device interface may include terminal tabs extending in the same direction. The terminal tabs of the second device interface are embedded into the clips of the second battery interface 112 along the preceding extension direction such that the battery pack 103 is mounted to or detached from the second electric device through a clip-type plug-in method. The clip-type plug-in method is a traditional sliding plug-in method for connecting power tools and battery packs.

In some examples, as shown in FIG. 2, the first battery interface 111 can transmit electric energy but differs from the preceding second battery interface 112. The first battery interface 111 may at least include a positive terminal 1111, a negative terminal 1112, and a communication terminal. The positive terminal 1111 and the negative terminal 1112 are configured to transmit electric energy of the battery pack 103. The communication terminal is configured to transmit data of the battery pack 103. In addition, the preceding positive terminal 1111 and the preceding negative terminal 1112 each having a discharge current of greater than 20 A are discrete terminals. The so-called discrete terminals (also referred to as separate terminals) mean that the positive terminal 1111 and the negative terminal 1112 exist as two discrete (separate) elements with a certain distance therebetween. Therefore, the first battery interface is different from an electrical interface whose positive and negative terminals are integrated on a certain micro board as two pins, such as a USB interface.

In some examples, as shown in FIGS. 2 and 3, the preceding first battery interface 111 and the preceding second battery interface 112 may be disposed on different side end surfaces of the battery pack 103, respectively. For example, the preceding first battery interface 111, that is, the interface electrically coupled to the first device interface of the first electric device, is disposed on the rear end surface of the battery pack 103 or the rear end surface of the housing assembly 120. The preceding second battery interface 112, that is, the interface electrically coupled to the second device interface of the second electric device, is disposed on the upper end surface of the battery pack 103 or the upper end surface of the housing assembly 120. Thus, the use and design of dual-interface coupling are facilitated. The battery interfaces disposed on the different side end surfaces may use different guide rails for guidance and each have at least partially different locking assemblies 140. In other examples, the preceding first battery interface 111 and the preceding second battery interface 112 may be disposed on the wall surface of the same side of the battery pack 103 to share some components.

In some examples, the first battery interface 111 and the second battery interface 112 may have the same or similar electrical characteristics. For example, the rated voltage of the first battery interface 111 and the rated voltage of the second battery interface 112 may be approximately the same. For example, the battery pack 103 may be configured to supply power to the same type of products of two generations. Similarly, one or more of the average discharge currents, the maximum discharge currents, the average output power, and the like of the first battery interface 111 and the second battery interface 112 may also be approximately the same. In other examples, the electrical characteristics of the first battery interface 111 and the electrical characteristics of the second battery interface 112 may be different or at least partially different. For example, the rated voltage of the first battery interface 111 and the rated voltage of the second battery interface 112 may be unequal.

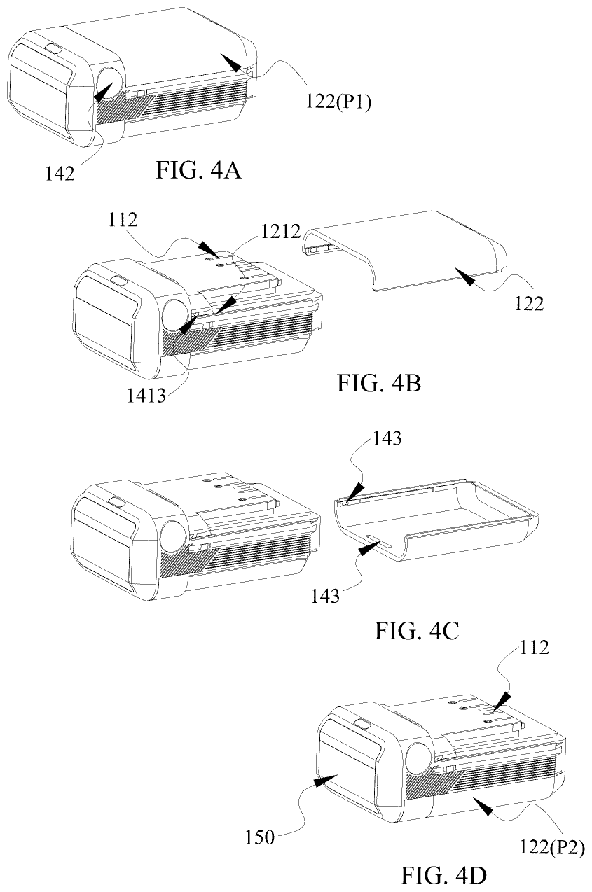

In some examples, as shown in FIG. 2, in addition to the first battery interface 111 and the second battery interface 112 that are configured to charge and discharge the cells, the preceding battery pack 103 further includes a USB interface 113 configured to charge and/or transmit data to an external device such as a mobile phone or a tablet computer. For example, the USB interface 113 may be disposed on the rear end surface of the battery pack 103. In some examples, as shown in FIGS. 4A to 4D, the preceding battery pack 103 further includes a device 150 for displaying an electric quantity. The device 150 for displaying an electric quantity can at least display information about the electric quantity, such as a real-time remaining electric quantity of the battery pack 103. The device 150 for displaying an electric quantity may be disposed at the front end of the battery pack 103. For example, the device 150 for displaying an electric quantity may include a display screen disposed on the front end surface of the battery pack 103 or the front end surface of the housing assembly 120. In some examples, the information about the electric quantity of the battery pack 103 further includes information such as the duration for which the battery pack 103 can continue operating. Furthermore, the preceding device 150 for displaying an electric quantity may also display information about a health degree or aging information such as the maximum recoverable capacity of the battery pack 103 and may display other diverse information.

The guide rails on the battery pack 103 are further described below. In some examples, as shown in FIGS. 2 to 8, a first guide rail 1211 and a second guide rail 1212 are formed on the housing assembly 120 of the battery pack 103. The first guide rail 1211 and the second guide rail 1212 guide the electrical connection of the preceding two battery interfaces, respectively. The first guide rail 1211 guides detachable electrical connection between the first battery interface 111 and the first electric device such as the first power tool 201 while the second guide rail 1212 guides detachable electrical connection between the second battery interface 112 and the second electric device such as the second power tool 202. In some examples, the preceding first guide rail 1211 and the preceding second guide rail 1212 may be provided on different planes without interfering with each other, thereby facilitating the design and implementation of the locking assemblies 140 that mate with the guide rails. For example, the planes where the first guide rail 1211 and the second guide rail 1212 are located may be parallel to each other or may be perpendicular to each other. However, in the case where the planes where the first guide rail 1211 and the second guide rail 1212 are located intersect, the two rails do not intersect. For example, the preceding first guide rail 1211 and the preceding second guide rail 1212 are linear guide rails and may each include two parallel rails formed on the left and right end surfaces of the housing assembly 120 of the battery pack 103. The first guide rail 1211 extends along a front and rear direction. The straight line at which the first guide rail 1211 is located is perpendicular to the rear end surface of the battery pack 103 where the first battery interface 111 is located. The first guide rail 1211 is used for guiding the preceding first battery interface 111. The second guide rail 1212 extends along the front and rear direction. The plane where the second guide rail 1212 is located is parallel to the plane where the first guide rail 1211 is located. Optionally, the second guide rail 1212 is located above the first guide rail 1211 and is used for guiding the preceding second battery interface 112. In other examples, one of the first battery interface 111 and the second battery interface 112 may be guided by two guide rails while the other may be guided by only one guide rail. In other examples, only one guide rail may be formed on the housing assembly 120 of the battery pack 103. This guide rail may guide electrical connection of at least one battery interface. For example, one of the first battery interface 111 and the second battery interface 112 is guided by the guide rail while the other is not guided, does not need to be guided, or is guided in another manner other than the guide rail. For another example, both the first battery interface 111 and the second battery interface 112 are guided by the guide rail. However, the movement track generated by the guide to the first battery interface 111 on the guide rail differs from the movement track generated by the guide to the second battery interface 112 on the guide rail. The differences include opposite movement directions or different ranges in which the movements are enabled.

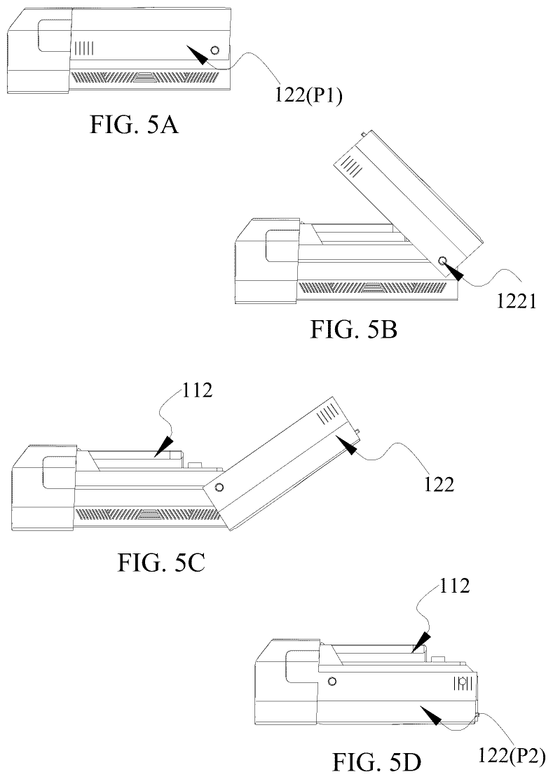

Optionally, with reference to FIGS. 4A to 5D, the battery pack 103 having a cover 122 is provided. The battery pack 103 has the cover 122 mountable to the housing assembly 120 to cover the battery interface and having at least two mounting positions so that the battery pack 103 is protected and the convenience and aesthetics of the battery pack 103 are also improved. The example of the battery pack 103 provided here may be combined with the example of the battery pack 103 described above. As shown in FIGS. 4A to 5D, the battery pack 103 includes the housing assembly 120, the battery module 130, and at least one battery interface. The battery interface is detachably and electrically connectable to electric devices such as a power tool and a charging device, to supply power to the power tool or to charge the battery pack 103 through the charging device. The battery interface is electrically coupled to the device interface and matches the device interface both electrically and mechanically. In addition, the preceding battery pack 103 further includes the cover 122 mounted on the housing assembly 120. The cover 122 can cover at least one battery interface and can be mounted at two different mounting positions of the housing assembly 120 in a detachable or non-detachable manner: a first mounting position P1 and a second mounting position P2. The coverage of the battery interface by the cover 122 mounted at the first mounting position is at least partially different from the coverage of the battery interface by the cover 122 mounted at the second mounting position. In some examples, in the case where the cover 122 is mounted at the first mounting position, the cover 122 covers the at least one battery interface, and in the case where the cover 122 is mounted at the second mounting position, the battery interface previously covered is exposed. In some examples, as described above, the battery pack 103 has the first battery interface 111 and the second battery interface 112, where the cover 122 covers the second battery interface 112 when the cover 122 is mounted at the first mounting position, and the second battery interface 112 is exposed when the cover 122 is mounted at the second mounting position. Furthermore, the cover 122 may not cover the first battery interface 111 at the first mounting position or the second mounting position.

Exemplarily, as shown in FIGS. 4A to 4D and FIGS. 5A to 5D, the battery pack 103 is the preceding battery pack 103 for a power tool having a transition function. One of the first battery interface 111 and the second battery interface 112 of the battery pack 103 for a power tool is electrically connected. The second battery interface 112, which is configured as the electrode tab interface, forms an uneven surface of the housing when not in use. The uneven surface of the housing is neither aesthetically pleasing nor resistant to damage. It is inconvenient to place the battery pack 103 for a power tool when it is not in use or assemble the first battery interface 111 to the first power tool 201. After the preceding cover 122 is further provided, as shown in FIG. 4A, in the case where the second battery interface 112 is not in use, the cover 122 is located at the first mounting position, for example, the upper end surface of the battery pack 103 and covers the second battery interface 112 so that the battery pack 103 is complete and not defective in this case. Moreover, since the first battery interface 111 and the second battery interface 112 are located on different end surfaces of the battery pack 103, the coverage of the second battery interface 112 by the cover 122 does not interfere with electrical coupling between the first battery interface 111 and the first device interface. As for the case where the second battery interface 112 is in use, as shown in FIG. 4D, the cover 122 is located at the second mounting position, for example, the lower end surface of the battery pack 103, and the second battery interface 112 is exposed, thereby allowing electrical coupling between the second device interface and the second battery interface 112. In addition, the cover 122 at the second mounting position does not need to be detached from the battery pack 103 and thus will not be lost. The cover 122 having a support plane is designed, which does not affect the stability with which the electric device such as the power tool is placed.

In some examples, as shown in FIGS. 4A to 4D, the cover 122 is detachably mounted to the battery pack 103. The switchover of the cover 122 between the different mounting positions requires the detachment of the cover 122 from the battery pack 103. Exemplarily, the cover 122 can be snap-fitted onto the housing assembly 120 to cover the end surface where the battery interface is located. In some examples, the mounting and detachment of the cover 122 configured as a sliding cover may further be assisted by the guide rail described above for guiding the electrical connection of the battery interface. Furthermore, the guide rails corresponding to the first mounting position and the second mounting position respectively may be formed on the housing assembly 120 of the battery pack 103.

In some examples, as shown in FIGS. 5A to 5D, the cover 122 is mounted to the battery pack 103 in a non-detachable manner. The switchover of the cover 122 between the different mounting positions does not require the detachment of the cover 122 from the battery pack 103. Exemplarily, the cover 122 may rotate to switch between the first mounting position and the second mounting position. The battery pack 103 is provided with a rotary shaft 1221 for the cover 122. The cover 122 configured as a flip cover is rotatable about the rotary shaft 1221 and is slidable along a straight line passing through the rotary shaft 1221 when or after being flipped. The first mounting position and the second mounting position may be located at two ends of the preceding straight line segment for sliding, respectively, and the cover 122 may be flipped 180° at the two mounting positions.

As described above, the device is locked when the preceding battery pack 103 is mounted to the power tool, which is described below. The battery pack 103 described in the preceding examples may further include a locking assembly 140. As shown in FIGS. 2 to 8, the locking assembly 140 at least locks and/or releases a device corresponding to the process where one battery interface is electrically coupled. Specifically, in the case where the preceding battery pack 103 is electrically connected to the electric device through the first battery interface 111, the battery pack 103 is locked to the first electric device such as the first power tool 201. Alternatively, in the case where the preceding battery pack 103 is electrically connected to the electric device through the second battery interface 112, the battery pack 103 is locked to the second electric device such as the second power tool 202. In some examples, the locking assembly 140 may be used for locking both the first electric device corresponding to the first battery interface 111 and the second electric device corresponding to the second battery interface 112. The battery pack 103 shares at least part of the locking assembly 140 when locked to the first power tool 201 and the second power tool 202.

In some examples, the locking assembly 140 of the battery pack 103 includes a locking portion 141. A corresponding mating portion is provided on the power tool. In a mounting process, the locking portion 141 cooperates with the mating portion to lock the battery pack 103 and the power tool. In some examples, the locking portion and the mating portion may form a snap-fit connection. For example, the locking portion may be a snap joint that abuts against an elastic member such as a spring, and the mating portion is a locking slot into which the snap joint can be embedded to form a locking relationship. In some examples, as shown in FIGS. 2 and 3, the locking assembly 140 may include a first locking portion 1411 disposed on the upper end surface of the battery pack 103. An elastic member in the first locking portion 1411 elastically deforms in a direction perpendicular to the upper end surface, the compression direction of the elastic member is downward, and the expansion direction of the elastic member is upward. The second battery interface 112 electrically coupled to the second device interface is also disposed on the upper end surface of the battery pack 103. The corresponding mating portion is disposed on the surface of the second power tool 202 where the second device interface is located, that is, the contact surface of the upper end surface of the battery pack 103. When the battery pack 103 is mounted to the second electric device, the device housing is pressed downward to limit the first locking portion 1411 into a compressed state, and until the mating portion arrives, the first locking portion 1411 is embedded into the mating portion and expands, thereby locking the battery pack 103 to the second electric device.

In other examples, as shown in FIGS. 2 and 3, the locking assembly 140 may further include a second locking portion 1412 disposed in the first guide rail 1211. An elastic member in the second locking portion 1412 elastically deforms in a direction perpendicular to the straight line where the first guide rail 1211 is located, the compression direction of the elastic member is inward, and the expansion direction of the elastic member is outward. The first battery interface 111 electrically coupled to the first device interface is disposed on the rear end surface of the battery pack 103. The first guide rail 1211 is perpendicular to the rear end surface. The first power tool 201 is provided with a rib, where the rib can be embedded into the first guide rail 1211 and is guided by the first guide rail 1211 for translation, and the rib is provided with a corresponding mating portion. When the battery pack 103 is mounted to the first electric device, the preceding rib pushes the second locking portion 1412 to move inward and causes the second locking portion 1412 to be in a compressed state, and until the mating portion arrives, the second locking portion 1412 is embedded into the mating portion and expands, thereby locking the battery pack 103 to the first electric device.

In some examples, as shown in FIG. 2 and FIGS. 4A to 5D, the locking assembly 140 is further configured to lock the cover 122 to or release the cover 122 from the housing assembly 120 of the battery pack 103. Exemplarily, the cover 122 is at the first mounting position P1 on the housing assembly 120 of the battery pack 103 to cover the second battery interface 112, and the cover 122 is at the second mounting position P2 on the housing assembly 120 of the battery pack 103 to expose the second battery interface 112. The locking assembly 140 may lock the cover 122 to or release the cover 122 from the preceding first mounting position or the preceding second mounting position. As shown in FIGS. 4A to 4D, when the cover 122 is mounted to the first mounting position on the housing assembly 120, the cover 122 may be guided by the second guide rail 1212. The locking assembly 140 may include a third locking portion 1413 disposed in the second guide rail 1212. An elastic member in the third locking portion 1413 elastically deforms in a direction perpendicular to the straight line where the second guide rail 1212 is located, the compression direction of the elastic member is inward, and the expansion direction of the elastic member is outward. A rib is provided on the inner wall of the cover 122 configured as the sliding cover, where the rib can be embedded into the second guide rail 1212 and is guided by the second guide rail 1212 for translation, and the rib is provided with a corresponding mating portion. When the cover 122 is mounted at the first mounting position of the housing assembly 120, the preceding rib pushes the third locking portion 1413 to move inward and causes the third locking portion 1413 to be in a compressed state, and until the mating portion arrives, the third locking portion 1413 is embedded into the mating portion and expands, thereby locking the cover 122 to the housing assembly 120. In addition, as shown in FIG. 7, the third locking portion 1413 in the second guide rail 1212 may also lock the battery pack 103 to the second power tool 202 when the battery pack 103 is electrically connected to the second power tool 202 as long as a corresponding rib is provided on the housing of the second power tool 202 or another device, where the rib includes a mating portion and can be embedded into the second guide rail 1212. In some examples, when the cover 122 is mounted to the second mounting position, the cover 122 is guided by another guide rail. A locking portion may also be disposed in this guide rail, which is similar to the preceding description and is not repeated here. In other examples, the first locking portion 1411 may also be used to lock the cover 122 to the housing assembly 120, and the inner wall of the cover 122 may be provided with a mating portion corresponding to the first locking portion 1411.

In some examples, as shown in FIGS. 2 to 4D, the locking assembly 140 further includes an unlocking button 142. The unlocking button 142 is operable by the user to unlock the battery pack 103 from the electric device. The unlocking button 142 may be disposed on a sidewall of the battery pack 103, including but not limited to the front end surface of the battery pack 103, the front end of the upper end surface of the battery pack 103, and the left and/or right end surface of the battery pack 103. In some examples, the preceding unlocking button 142 may be linked with the elastic member in the locking portion 141 such as the spring. Upon the operation of the unlocking button 142, the locking portion 141 may be driven by the elastic member to disengage from the mating portion. In some examples, some transmission members for converting directions in which forces are born and applied also exist between the unlocking button 142 and the elastic member or between the elastic member and the locking portion 141 so that there are more options for the arrangement of the locking assembly 140 and the position of the locking assembly 140.

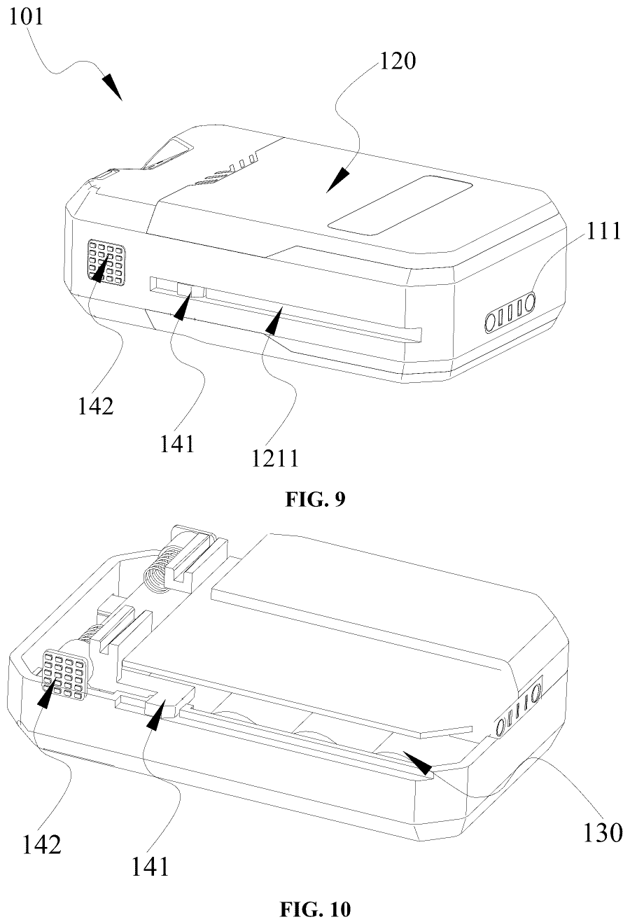

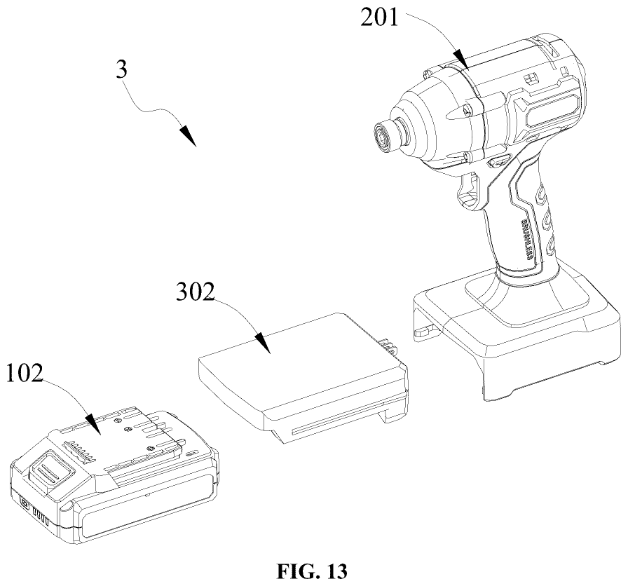

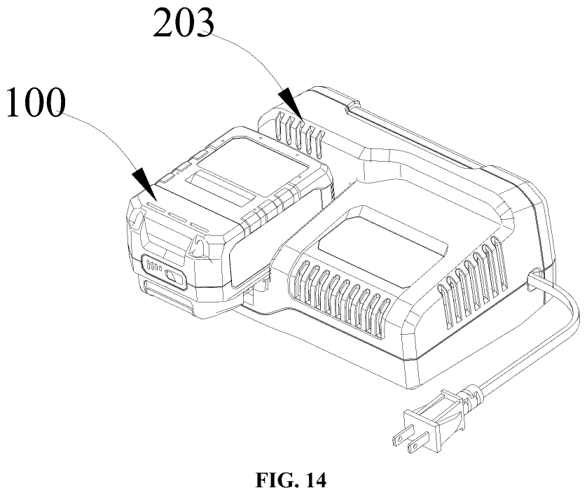

Secondly, in another optional example of the present application, referring to FIGS. 9 to 12, the battery pack 101 is proposed. The battery pack 101 has the same first battery interface 111 as the battery pack 103 described in the preceding examples and is intended to supply power to the first power tool 201 described in the preceding examples. The first power tool 201 is one of the two types or two generations of power tools to which the battery pack 103 is adapted. In some examples, the battery pack 101 is a new-generation battery pack for serving a new-generation power tool. For clarity of the present application, the preceding battery pack 101 provided with only the first battery interface 111 is referred to as a first battery pack 101 hereinafter, as shown in FIG. 9 to FIG. 12. In addition, a battery pack provided with only the second battery interface 112, that is, a battery pack that supplies power to the second power tool 202 described in the preceding examples, is referred to as a second battery pack 102, as shown in FIG. 13. The second power tool 202 is the other of the two types or two generations of power tools to which the battery pack 103 is adapted. In some examples, the battery pack 102 is the old battery pack for serving a previous-generation power tool. In some examples, the preceding first power tool 201 includes not only conventional power tools such as cutting power tools, fastening power tools, sanding power tools, and garden tools, but also household power tools such as vacuum cleaners and fans. The first battery pack 101 may supply power to these two types of power tools. However, the second power tool 202 only includes the conventional power tools described above. The second battery pack 102 supplies power to only this type of power tools. In addition, the present application also proposes a battery system 2a including the first battery pack 101 and the first electric device such as the first power tool 201 and a battery system 2b including the first battery pack 101, a first conversion apparatus 301, and the second electric device such as the second power tool 202.

As shown in FIGS. 9 to 12, the preceding first battery pack 101 may include a housing assembly 120 and a battery module 130. The housing assembly 120 forms the appearance of the first battery pack 101, and an accommodation space is formed inside the housing assembly 120. The battery module 130 is disposed in the accommodation space and may include multiple cells used as energy storage elements in the first battery pack 101. The material and dimension of the housing assembly 120 and the type and number of the cells are not specifically limited. As described above, the first battery pack 101 includes the first battery interface 111 but does not include the second battery interface 112. The first battery interface 111 may be disposed on the rear end surface of the first battery pack 101 or the front end surface of the first battery pack 101. The first battery pack 101 is detachably and electrically connectable to the first power tool 201 through the first battery interface 111. Exemplarily, the first battery interface 111 is electrically coupled to the first device interface of the first electric device such as the first power tool 201. In some examples, the first battery interface 111 includes a positive terminal 1111, a negative terminal 1112, and a communication terminal. The preceding positive terminal 1111 and the preceding negative terminal 1112 are discrete (separate) terminals. For example, the first battery interface 111 may include the positive terminal 1111 located on the left side of the rear end surface of the first battery pack 101 and the negative terminal 1112 located on the right side of the rear end surface of the first battery pack 101. In some examples, the discharge current of the preceding first battery interface 111 is greater than 20 A. In some examples, the first battery pack 101 further includes a USB interface 113. In the case where the first battery interface 111 is disposed on the rear end surface, the USB interface 113 may be disposed on the front end surface of the first battery pack 101 so that the interfaces are appropriately spaced. Of course, the USB interface 113 may also be disposed on the rear end surface.

In addition, the preceding first battery pack 101 further includes a first guide rail 1211 and a locking assembly 140. The first guide rail 1211 is formed on a side surface of the first battery pack 101, including but not limited to the left and right end surfaces and/or the upper end surface and can guide electrical connection at the first battery interface 111. In some examples, the first guide rail 1211 is a linear guide rail. The straight line where the first guide rail 1211 is located is perpendicular to the rear end surface of the first battery pack 101 where the first battery interface 111 is located. A rib is provided on the device housing of the first electric device such as the first power tool 201, where the rib can be embedded into the first guide rail 1211 and is guided by the first guide rail 1211 for translation. In this example, the locking assembly 140 is an operable component. The locking assembly 140 can be operated by the user to lock the first battery pack 101 to or release the first battery pack 101 from the first electric device to which the first battery interface 111 is electrically connected, such as the first power tool 201. In some examples, the locking assembly 140 includes a locking portion 141 and an unlocking button 142. The locking portion 141 is at least partially located on the housing assembly 120 so as to cooperate with a mating portion on the first electric device to lock the first battery pack 101 to the first electric device when the first battery pack 101 is mounted. The unlocking button 142 may be disposed on the left end surface, the right side surface, or another side surface of the first battery pack 101. The unlocking button 142 can be operated by the user to unlock the first battery pack 101 and the first electric device from the locking portion 141. For example, the locking portion 141 and the mating portion may form a snap-fit structure. The locking portion 141 includes a snap joint connected to one end of an elastic member, and the unlocking button 142 is an operation member connected to the other end of the elastic member, such as a push button. As shown in FIG. 10, the locking portion 141 has a protrusion located within the first guide rail 1211. The protrusion extends out of the housing through a through hole in the first guide rail 1211 to be in contact with the device. The rib on the first electric device guided by the first guide tail 1211 is provided with the mating portion for the protrusion of the locking portion 141 to be embedded into. The locking portion 141 is connected to a spring in the housing. The user presses the unlocking button 142 to move the unlocking button 142 toward the inside of the housing in a left and right direction, causing the spring connected to the unlocking button 142 to move toward the inside of the housing in the left and right direction. Then, the locking portion 141 connected to the spring is also moved to the inside of the housing in the left and right direction. Therefore, the protrusion of the locking portion 141 is disengaged from the mating portion, the mating portion is no longer limited by the locking portion 141, and the first electric device and the first battery pack 101 are unlocked.

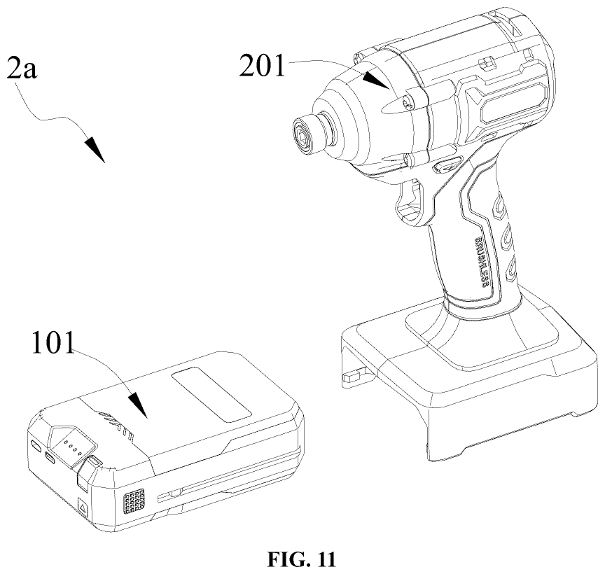

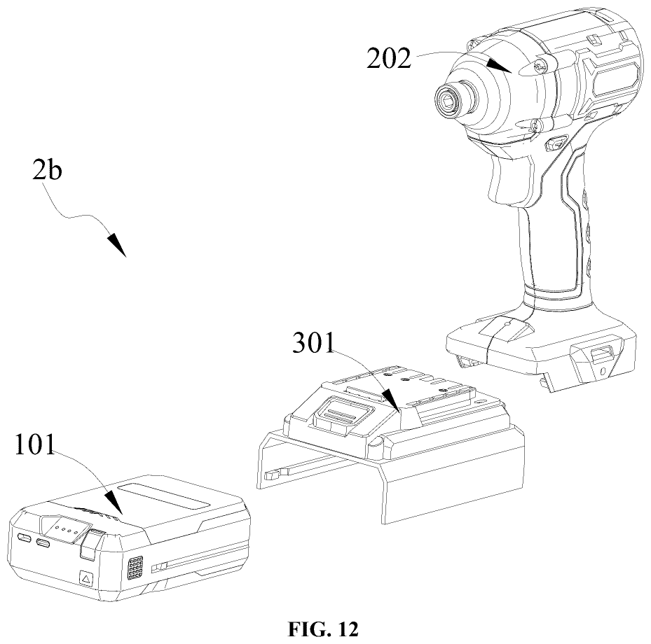

As shown in FIG. 11, the first battery pack 101 and the first electric device mentioned above form the battery system 2a. When the first battery pack 101 is configured to supply power to the first power tool 201, no intermediate adapter device is required, and the first battery interface 111 can be electrically coupled to the first device interface directly. As shown in FIG. 12, the first battery pack 101, the first conversion apparatus 301, and the second electric device mentioned above form the battery system 2b. When the first battery pack 101 is configured to supply power to the second power tool 202, an intermediate device, that is, the first conversion apparatus 301, is required to function as an adapter, and the first battery interface 111 cannot be electrically coupled to the second device interface directly. The preceding first conversion apparatus 301 includes a first adapter interface and a second adapter interface. The first adapter interface is identical or similar to the first device interface and is configured to be electrically coupled to the first battery interface 111 of the first battery pack 101. The second adapter interface is identical or similar to the second battery interface 112 and is configured to be electrically coupled to the second device interface of the second power tool 202. Thus, the electric energy transmission relationship of the first battery interface 111 of the first battery pack 101—the first adapter interface of the first conversion apparatus 301—the second adapter interface of the first conversion apparatus 301—the second device interface of the second power tool 202 is formed. In some examples, electric energy processing such as voltage boosting and voltage bucking is not performed between the first adapter interface of the first conversion apparatus 301 and the second adapter interface of the first conversion apparatus 301, and the first conversion apparatus 301 is only configured to implement interface structure conversion. In some examples, the first adapter interface of the first conversion apparatus 301 may be disposed on the front end surface of the first conversion apparatus 301 or the rear end surface of the first conversion apparatus 301 to facilitate electrical connection to the first battery interface 111 on the rear end surface of the first battery pack 101. The first adapter interface matches the first battery interface 111 and is configured to have a discrete terminal structure. In some examples, the second adapter interface of the first conversion apparatus 301 may be disposed on the upper end face of the first conversion apparatus 301 so as to have a similar shape to that of the second battery pack 102. The second adapter interface is equivalent to the second battery interface 112 and may be configured as an electrode tab interface. The second adapter interface includes electrode tabs located in one extension direction. The second device interface of the second power tool 202 is mounted to or detached from the second adapter interface of the first conversion apparatus 301 through a clip-type plug-in method along the extension direction.

Next, the second battery pack 102 mentioned above is described. Referring to FIG. 13, the second battery pack 102 may include a housing assembly 120 and a battery module 130. As described above, the second battery pack 102 includes the second battery interface 112 but does not include the first battery interface 111. The second battery interface 112 may be disposed on the upper end surface of the second battery pack 102. The second battery pack 102 is detachably and electrically connectable to the second power tool 202 through the second battery interface 112. Exemplarily, the second battery interface 112 is electrically coupled to the second device interface of the second electric device such as the second power tool 202 directly. In some examples, the second battery interface 112 is the electrode tab interface and includes electrode tabs located in one extension direction. The second power tool 202 is mounted to or detached from the second battery interface 112 through a clip-type plug-in method along the extension direction via the second device interface. As shown in FIG. 13, the second battery pack 102, the second conversion apparatus 302, and the first electric device form a battery system 3. When the second battery pack 102 supplies power to the first power tool 201, an intermediate device, that is, the second conversion apparatus 302, is required to function as an adapter, and the second battery interface 112 cannot be electrically coupled to the first device interface directly. The preceding second conversion apparatus 302 includes a third adapter interface and a fourth adapter interface. The third adapter interface is identical or similar to the second device interface and is configured to be electrically coupled to the second battery interface 112 of the second battery pack 102. The fourth adapter interface is identical or similar to the first battery interface 111 and is configured to be electrically coupled to the first device interface of the first power tool 201. Thus, the electric energy transmission relationship of the second battery interface 112 of the second battery pack 102—the third adapter interface of the second conversion apparatus 302—the fourth adapter interface of the second conversion apparatus 302—the first device interface of the first power tool 201 is formed. In some examples, the third adapter interface of the second conversion apparatus 302 may be disposed on the lower end surface of the second conversion apparatus 302 to facilitate electrical connection to the second battery interface 112 on the upper end surface of the second battery pack 102. The third adapter interface matches the second battery interface 112 configured as the electrode tab interface and can be mounted to or detached from the second battery interface 112 through a clip-type plug-in method along the extension direction of each of the electrode tabs. In some examples, the fourth adapter interface of the second conversion apparatus 302 may be disposed on the front end face of the second conversion apparatus 302 or the rear end surface of the second conversion apparatus 302 so as to have a similar shape to that of the first battery pack 101. The fourth adapter interface is equivalent to the first battery interface 111 and may be configured to have a discrete terminal structure. In addition, the preceding second battery pack 102 and the second electric device may also form a battery system. When the second battery pack 102 is configured to supply power to the second power tool 202, no intermediate adapter device is required, and the second battery interface 112 can be electrically coupled to the second device interface directly.

In some examples, the preceding conversion apparatus is also referred to as an adapter. It is to be understood that multiple examples relating to the cover, the locking assembly, and the like in the example of the battery pack 103 may be incorporated into the first battery pack 101 or the second battery pack 102 and their battery system on the premise that no content conflicts arise.

Finally, the battery system that may be formed by combining the preceding multiple examples involves at most three types of battery packs, that is, the first battery pack 101, the second battery pack 102, and the transition battery pack 103, two types of power tools, that is, the first power tool 201 and the second power tool 202, two types of adapters, that is, the first adapter 301 and the second adapter 302, and two types of charging devices, that is, the first charging device and the second charging device. The battery system described in each example may involve one or more of the preceding devices. In the case where the transition battery pack is not included, if the serial numbers of the battery pack and the power tool are consistent or the serial numbers of the battery pack and the charging device are consistent, no adapter as the intermediate device is required, and if the serial numbers of the battery pack and the power tool are inconsistent or the serial numbers of the battery pack and the charging device are inconsistent, the adapter as the intermediate device is required. In the case where the transition battery pack is included, any power tool can be powered by the transition battery pack, any charging device can charge the transition battery pack, and the adapter is not required.

At least one of the technical effects of the present application is as follows: the product compatibility of the battery pack for a power tool can be improved.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A battery pack for a power tool, comprising:
a housing assembly;
a battery module disposed within the housing assembly;
a first battery interface detachably and electrically connectable to at least a first power tool to supply power to the first power tool;
a second battery interface detachably and electrically connectable to at least a second power tool to supply power to the second power tool, wherein a discharge current of the first battery interface and a discharge current of the second battery interface are each greater than 20 A; and
at least one guide rail formed on the housing assembly that guides at least one of the first power tool to the first battery interface and the second power tool to the second battery interface.

2. The battery pack for a power tool according to claim 1, wherein the at least one guide rail comprises: a first guide rail that guides the first battery interface to the first power tool; and a second guide rail that guides the second battery interface to the second power tool.

3. The battery pack for a power tool according to claim 2, wherein the first guide rail and the second guide rail are provided on different planes.

4. The battery pack for a power tool according to claim 1, wherein the first battery interface is disposed on a rear end surface of the battery pack, and the second battery interface is disposed on an upper end surface of the battery pack.

5. The battery pack for a power tool according to claim 1, wherein a rated voltage of the first battery interface and a rated voltage of the second battery interface are substantially the same.

6. The battery pack for a power tool according to claim 1, wherein a rated voltage of the first battery interface and a rated voltage of the second battery interface are different from each other.

7. The battery pack for a power tool according to claim 1, wherein the first battery interface comprises a positive terminal, a negative terminal, and a communication terminal, and the positive terminal and the negative terminal are discrete terminals.

8. The battery pack for a power tool according to claim 7, wherein the first battery interface is a non-Universal Serial Bus (USB) interface.

9. The battery pack for a power tool according to claim 7, wherein the first battery interface is detachably and electrically connected to a first electric device, and the second battery interface is detachably and electrically connected to a second electric device.

10. The battery pack for a power tool according to claim 2, wherein the second battery interface is an electrode tab interface, the second battery interface comprises electrode tabs, and a second electric device is mounted to or detached from the second battery interface through a clip-type plug-in method along an extension direction of each of the electrode tabs.

11. The battery pack for a power tool according to claim 1, further comprising a USB interface, wherein the USB interface is disposed on a rear end surface of the battery pack.

12. The battery pack for a power tool according to claim 1, further comprising a device for displaying an electric quantity, wherein the device for displaying an electric quantity is disposed at a front end of the battery pack and is configured to display at least information about an electric quantity of the battery pack.

13. The battery pack for a power tool according to claim 1, further comprising a cover, wherein the cover is mounted on the housing assembly, the cover has two different mounting positions on the housing assembly, when the cover is at a first mounting position on the housing assembly, the second battery interface is covered, and, when the cover is at a second mounting position on the housing assembly, the second battery interface is exposed.

14. The battery pack for a power tool according to claim 13, further comprising a locking assembly, wherein the locking assembly locks the cover to or releases the cover from the first mounting position.

15. The battery pack for a power tool according to claim 14, further comprising an unlocking button that unlocks the locking assembly to release the cover from the first mounting position, wherein the unlocking button is disposed on a side surface of the battery pack.

16. A battery system, comprising:
a first electrical device having a device interface;
a second electrical device having a device interface; and
a battery pack;
wherein the battery pack comprises:
a housing assembly;
a battery module disposed within the housing assembly;
a first battery interface detachably and electrically connectable to the device interface of the first electric device to perform charging and discharging between the battery pack and the first electric device;
a second battery interface detachably and electrically connectable to the device interface of the second electric device to perform charging and discharging between the battery pack and the second electric device, wherein a discharge current of the first battery interface and a discharge current of the second battery interface are each greater than 20 A; and
at least one guide rail formed on the housing assembly that guides at least one of the device interface of the first electrical device to the first battery interface and the device interface of the second electrical device to the second battery interface.

17. The battery system according to claim 16, wherein the second battery interface is an electrode tab interface, the second battery interface comprises electrode tabs, the second electric device is directly inserted into the second battery interface along an extension direction of each of the electrode tabs through a clip-type plug-in method, and the first battery interface comprises a positive terminal, a negative terminal, and a communication terminal, and the positive terminal and the negative terminal are discrete terminals.

18. The battery system according to claim 16, further comprising a cover and a locking assembly, wherein the cover is mounted on the housing assembly, when the cover is at a first mounting position on the housing assembly, the second battery interface is covered, when the cover is at a second mounting position on the housing assembly, the second battery interface is exposed, the locking assembly at least one of locks the battery pack to the first electric device when the battery pack is electrically connected to the first electric device through the first battery interface and locks the battery pack to the second electric device when the battery pack is electrically connected to the second electric device through the second battery interface.

19. A battery pack, comprising:
a housing assembly;
a battery module disposed within the housing assembly;
at least one battery interface detachably and electrically connectable to at least a power tool to supply power to the power tool; and
a cover mounted on the housing assembly and covering at least one battery interface, wherein the cover has two different mounting positions on the housing assembly.

20. The battery pack according to claim 19, wherein the cover is at least one of detachably mounted at one of the two different mounting positions on the housing assembly and the cover is switched between the two mounting positions about a rotary shaft.
